(19) United States
(12) Patent Application Publication
(10) Pub. No.: US 2015/0000538 A1
(43) Pub. Date: Jan. 1, 2015

(54) GRILL DEVICE

(71) Applicant: Arman EMAMI, Berlin (DE)

(72) Inventor: Arman Emami, Berlin (DE)

(21) Appl. No.: 14/362,482

(22) PCT Filed: Nov. 22, 2012
(86) PCT No.: PCT/DE2012/001142

§ 371 Date: Aug. 18, 2014

(30) Foreign Application Priority Data
Dec. 5, 2011 (DE) 10 2011 120 756.6

(51) Int. Cl. A47J 37/07

(52) U.S. Cl. CPC A47J 37/07
USPC 99/443 R; 99/445

(57) ABSTRACT

A grill device which has a frame in which heating means are arranged below a grate. The heating means have a grease-deflecting cover supported on the frame and has oblique guide plates for dripping grease below the heating means, via which the dripping grease can be directed towards a collecting channel. The grate (2) is arranged on a support (1.1) on the upper edge region of the frame (1) and is divided into grate sections. The grease-deflecting cover (3) is made of flat fins (3.1-3.m) that are arranged in sequence like blinds and are adjustably arranged above the heating means (4). The guide plates (5) are divided into overlapping guide plate sections (5.1, 5.2) which can be removed from the frame (1).

The invention relates to a grill device arranged in a frame, with electrical heating means and/or gas burners as heating means, which are arranged below a grate for the food to be grilled, with a cover for the heating means to prevent the dripping grease from coming into contact with the heating source and with obliquely arranged guide plates for dripping grease below the heating means, via which the grease is directed towards a collecting channel.

Such a grill device is known from U.S. Pat. No. 5,566,606 A, U.S. Pat. No. 6,260,478 B1 and US 2011/0 219 957 A1. The covers for the heating source are designed like a pitched roof or flat with chamfers towards the heating sources in this case. The guide plates for dripping grease are designed so as to have a large area. The grates are single-piece grates and arranged so that they can be removed.

These grill devices have substantial disadvantages with regard to user-friendliness, because the parts coming into contact with grease are in some cases fixedly mounted and moreover of a size which does not allow cleaning in a conventional domestic dishwasher.

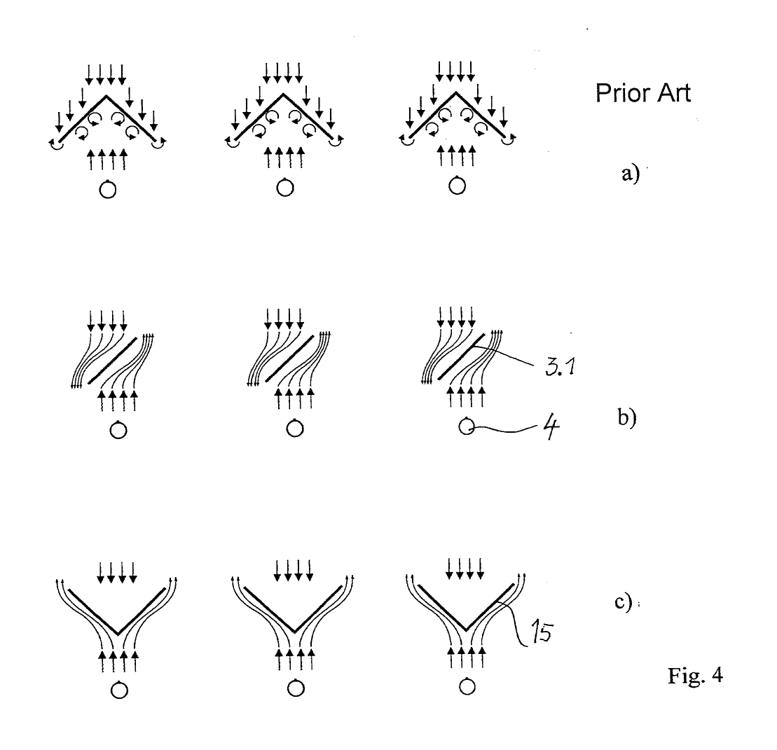

Covers for the heating sources designed like pitched roofs, such as also shown in FIG. 4 as state of the art, or flat covers chamfering towards the heating source are moreover disadvantageous in that, on the one hand, there is a build-up of heat below the cover such that grease burns on the cover and, on the other hand, in the edge regions there is a contact between the dripping grease and the heated air moving towards the food to be grilled. Also in this case grease can burn or deflagrations can occur.

If grid grates are used as grates, they are disadvantageous not only because they are not suitable for dishwashers due to their size, but also because parts of the food to be grilled will accumulate at the intersection points of the grid and scorch and stick there, which will be difficult to remove.

This is remedied to some extent by the grill device according to US 2011/0049125 A1, wherein the grate is divided into grate sections which can be joined together and removed from a basin of the frame.

The object of the invention is to propose a grill device with a frame-like rack whose parts are arranged so as to inhibit the accumulation of dirt and can be easily cleaned, preferably by being arranged in the frame so that they can be detached and placed into a dishwasher.

This object is achieved by a grill device having the features of claim 1, advantageous realisations are the subject-matter of the subclaims.

According to the invention, for a grill device which has a frame with a preferably cuboid-shaped design in which gas and/or electrical heating means are arranged below a grate, wherein the grate is arranged on a support of the upper edge region of the frame and is divided into grate sections which can be joined together and can be removed from the support of the frame, the heating means have a grease deflecting cover which is arranged so that it is supported on the frame and has oblique guide plates for dripping grease below the heating means, via which the dripping grease can be directed towards a collecting channel, it is proposed that
the grease-deflecting cover consists of flat fins which are arranged in sequence like blinds and are adjustably arranged above the heating means, wherein the individual fins are arranged so as to be detachable in the blind-like combination, and
the guide plates are divided into overlapping guide plate sections which can be removed from the frame.

The term grease as used herein includes meat juice as well as sauces applied to the food to be grilled or any liquids applied to the food to be grilled during grilling which will drip.

Such a structuring of the constructional units of the grill device essentially provides the basis for accessibility of the parts which are in contact with grease. They can be removed for cleaning purposes. Furthermore their size can be fixed such that the parts can be placed into conventional dishwashers, thus being able to be machine cleaned.

Moreover further advantageous realisations are provided.

It is proposed, for example, to provide the grate sections within the support region on the frame on both sides with support rails wherein grate bars arranged in parallel are supported so as to be able to rotate. Grate bars which can rotate in this manner allow the food to be grilled to be moved in the grate plane, in the case of food to be grilled having a circular cross-section also turning it over while performing a movement in the grate plane.

The knot-like intersection points of grid grates, which have a tendency to become dirty, have been omitted.

In a further realisation it is provided that the support rails of the grate sections have connecting means in or at end regions, by means of which connecting means a positive connection can be achieved between adjacent support rails arranged on the frame.

As an alternative or simultaneously it can also be provided that the support of the frame, at the point where the support rails are supported, has latches corresponding to latching means of the support rails such that the grate sections assume a defined position.

In both cases a stable grate is created which is continuous in the grate plane. The latches are easily accessible for cleaning purposes when the grate sections are removed. Connecting means at the support rails are machine-cleaned when the grate section is placed into the dishwasher.

Moreover the connecting elements or the latches can be used to replace grate sections by plates or grill devices for special preparations, wherein the plates or grill devices are supported on the support of the frame and can be connected to adjacent grate sections via the connecting means or have latching means corresponding to the latches of the support of the frame such that they can be fixed in this manner.

The heating means are protected from dripping grease by the fins arranged thereabove which can be pitched in an oblique manner. In an advantageous embodiment a pivot movement is provided for adjusting the fins, said movement occurring in a pivotal range of at least α=10-65°, with reference to a horizontal plane. Furthermore it is provided that the widths (b) of the fins are dimensioned such that, with the pitch angles within the pivotal range α, the respective upper lateral area of a fin is spaced at a distance (x) from the lower lateral area of the adjacent fin in a top view.

Thus, no build-up of heat occurs at the fins. The hot air from the heating means can reach the food to be grilled in an optimum heat flow while flowing against the fins from below. Dripping grease falls on the fins from above and is reliably deflected.

By changing the pitch angle of the fins the heat flow can be influenced without the deflection of the dripping grease being affected thereby over the long term.

Preferably elongated burners or heating rods are used as heating means, which are arranged in parallel with the grate bars. Preferably one or two burners/heating rods are provided for one grate section, wherein one fin is arranged above each burner/heating rod.

The heating means should be able to be activated and/or adjusted as to their heating power separately from one another.

In a further realisation of the grill device it is provided that the upper edge region of the frame has vertical insertion openings which, between one another, have a grid dimension (z), such that grill add-on elements having spigots spaced apart with the same grid dimension can be inserted into the insertion openings so as to form a positive connection.

Grill add-on elements are, for example, hot plates or trays. They can be removed from the insertion openings for cleaning. By appropriately selecting the grid dimensions and thus the size of the grill add-on elements said add-on elements can also be realised so as to be suitable for dishwashers.

Finally, in a preferred embodiment a cover hood for the grill zone is arranged on the frame, which cover hood can be opened by means of hinges, wherein the hinges can be displaced downwardly/upwardly on the back wall of the frame. The cover hood can thus be removed from the grill zone, but is readily available to be placed back on again.

The invention will now be explained with reference to the drawings in which

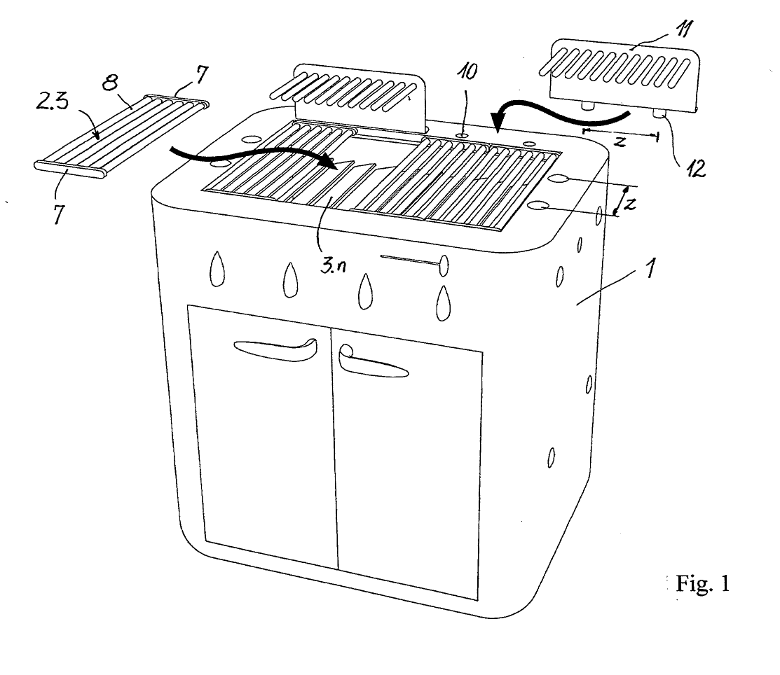

FIG. 1 shows a model of a grill,

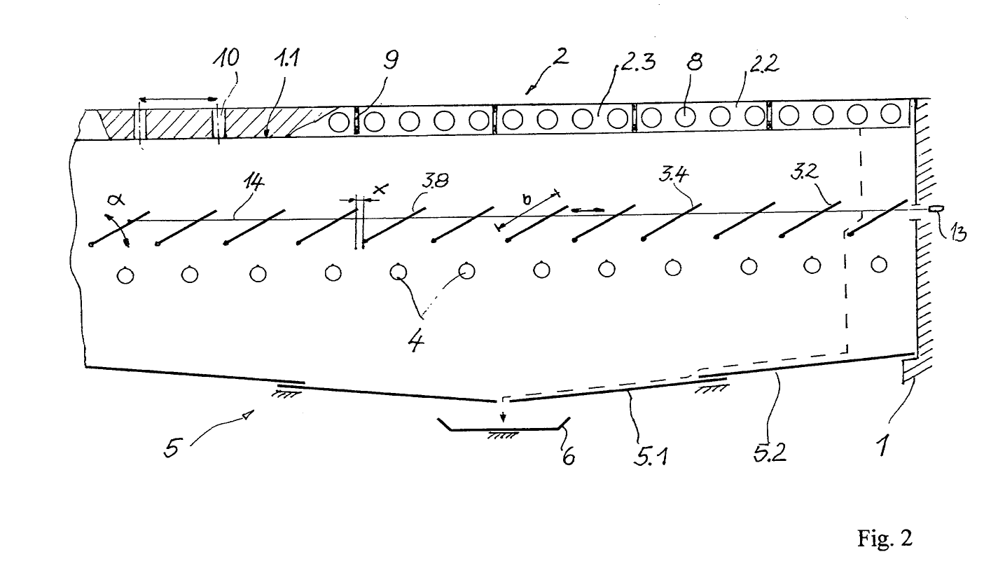

FIG. 2 shows the inner structuring of the constructional units of the grill,

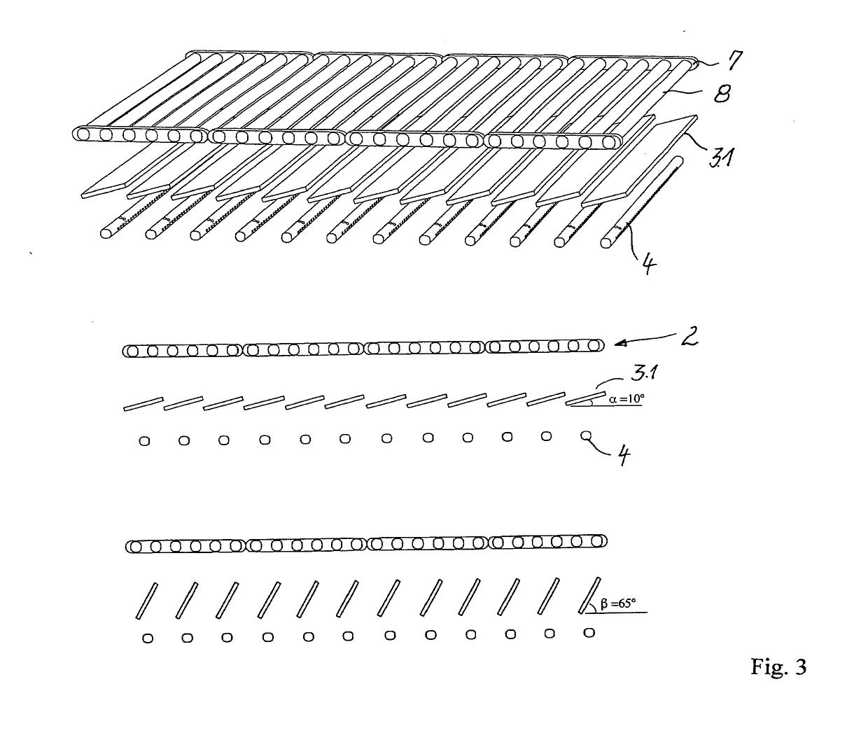

FIG. 3 shows the pitch of the fins and

FIG. 4 shows the heat flow and the grease discharge.

FIG. 1 shows a grill having a cuboid-shaped frame 1, which is covered in the lateral regions. The grill zone can be covered by a covering hood.

The covering hood is attached to the frame by means of hinges which, on the one hand, enable the covering hood to be opened and which can be displaced downwardly/upwardly on the back wall of the frame 1.

The grate 2 is arranged in the upper edge region of the frame 1 in a support 1.1 of the frame 1. The grate 2 is composed of grate sections 2.1-2.n, wherein each grate section 2.1-2.n can be removed separately from the support 1.1. The dimensions of the grate sections 2.1-2.n are selected such that the grate sections 2.1-2.n can be placed into a conventional dishwasher for cleaning.

Within the support region on the frame 1 each grate section 2.1-2.n is provided on both sides with support rails 7 wherein grate bars 8 arranged in parallel are supported so as to be able to rotate.

Grate sections 2i can also be replaced by plates or grill devices for special preparations, wherein the plates or grill devices are supported on the support 1.1 of the frame 1.

It is further shown that in the upper edge region of the frame 1 vertical insertion openings 10 are arranged which, between one another, have a grid dimension (z), such that grill add-on elements 11 having spigots 12 spaced apart with the same grid dimension can be inserted into the insertion openings 10 so as to form a positive connection. Warming racks are shown here as grill add-on elements 11.

FIG. 2 shows the inner structuring of the constructional units of the grill device.

The grill device has a frame 1 with a cuboid-shaped design in which gas and/or electrical heating means 4 are arranged below a grate 2.

The grate 2 is supported on a support 1.1 of the upper edge region of the frame 1 and is divided into grate sections 2.1-2.n which can be joined together and can be removed from the support 1.1 of the frame 1.

Within the support region on the frame 1 the grate sections 2.1-2.n are provided on both sides with support rails 7, in which the grate bars 8 arranged in parallel are supported so as to be able to rotate.

The support 1.1 of the frame 1, at the point where the support rails 7 are supported, has latches 9 corresponding to latching means of the support rails 7, such that the grate sections 2.1-2.n assume a defined position.

Grate sections 2.1-2.n can be replaced by plates or grill devices for special preparations, wherein the plates or grill devices are supported on the support 1.1 of the frame 1 and can be connected to adjacent grate sections 2.i by connecting means or have latching means which correspond to the latches 9 of the support 1.1 of the frame 1. In this manner, they also can be joined to form one grill surface in combination with grate sections 2.i.

The heating means 4 have a grease-deflecting cover in the form of fins 3.1-3.m which are arranged so as to be supported on the frame 1.

The heating means 4 consist of elongated burners or heating rods, wherein one grate section 2.1-2.n is provided for two burners/heating rods.

The grease-deflecting cover 3 consists of flat fins 3.1-3.m which are arranged in sequence like blinds and are adjustably arranged above the heating means 4, wherein the individual fins 3.1-3.m are arranged so as to be detachable in the blind-like combination. Adjusting the fins 3.1-3.m can be done by means of the indicated push rod 14 via a lateral handle 13 on the frame 1.

A pivot movement of the fins 3.1-3.m of at least α=10-65° with reference to a horizontal plane is provided for adjusting the fins 3.1-3.m.

The widths (b) of the fins 3.1-3.m are dimensioned such that, with the pitch angles within the pivotal range α, the respective upper lateral area of a fin—as illustrated for fins 3.9 and 3.8 by way of example—is spaced at a distance (x) from the lower lateral area of the adjacent fin in a top view.

Slopingly arranged guide plates 5 for dripping grease are located below the heating means 4, via which the dripping grease can be directed towards a collecting channel 6. The guide plates 5 are divided into overlapping guide plate sections 5.1, 5.2, which can be removed from the frame 1.

It is further shown that the upper edge region of the frame 1 has vertical insertion openings 10, which, between one another, have a grid dimension (z), such that grill add-on elements having spigots 12 spaced apart with the same grid dimension can be inserted into the insertion openings 10 so as to form a positive connection.

FIG. 3 shows the adjusting of the fins 3.1-3.m arranged like blinds above the heating means 4. The pitch angle α of the fins, with reference to the horizontal plane, is between 10-65°.

This angular span ensures that dripping grease which hits the fins 3.1-3.m is deflected. At the same time the heat flow can be significantly reduced or also intensified by this angular span.

FIG. 4 points out once again that, in contrast to the state of the art, which is shown in FIG. 4 a, with the arrangements of the invention according to FIGS. 4 b and 4 c there is no contact between the heat flow and the discharge flow of dripping grease on the one hand and the dripping grease and the heating means 4 on the other hand. For this purpose an obliquely adjusted fin 4 is arranged above each heating means 4 (FIG. 4 b) or also a sheet metal angle (15) with the opening facing upwardly (FIG. 4 c).

In the embodiment according to FIG. 4 c the sheet metal angle (15) at the same time fulfils a grease collecting and deflecting function for part of the grease. This means that the angle (15), with reference to its length, has to have an angle which is slightly inclined towards a grease discharge channel.

The oblique position of the fins 3.1-3.m and also that of the two legs of the sheet metal angle (15) ensure an optimum heat flow without any build-up of heat or turbulences such as illustrated in FIG. 4 a.

The present grill device combines functionality and ease of handling in an optimum way. The grill device strictly separates the heat flow from the grease discharge flow, such that no greasy substances are burnt and thus no harmful gases and/or unpleasant odours arise. The heat provided by the heating means is used for grilling, with only a minor part of the heat being lost. Additional equipment can be added to the grill device, wherein said additional equipment can be connected to the grill device in a simple manner.

After grilling no dirty device is left behind which has to be cleaned by hand in a laborious process, but rather, with only a few small steps, the grease-laden parts are placed into the domestic dishwasher, where they are machine-cleaned in a safe manner.

### LIST OF REFERENCE NUMERALS

1 frame
1.n support in the upper edge region of the frame
2 grate
2.1 grate sections
2.2 grate sections
2.n grate sections
3 grease-deflecting cover
3.1 fins
3.2 fins
3.m fins
4 heating means
5 guide plates
5.1 guide sections
5.2 guide sections
6 collecting channel for grease
7 support rail
8 grate bars
9 latch
10 insertion opening
11 grill add-on element
12 spigot
13 handle for push rod
14 push rod
15 sheet metal angle as a grease-deflecting cover

1. A grill device which has a frame with a cuboid-shaped design, in which gas and/or electrical heating means are arranged below a grate, wherein the grate is arranged on a support of the upper edge region of the frame and is divided into grate sections which can be joined together and can be removed from the support of the frame, wherein the heating means have a grease deflecting cover which is arranged so that it is supported on the frame and has oblique guide plates for dripping grease below the heating means, via which the dripping grease can be directed towards a collecting channel, wherein
the grease-deflecting cover (3) comprises flat fins (3.1-3.m) which are arranged in sequence like blinds and are adjustably arranged above the heating means (4), wherein the individual fins (3.1-3.m) are arranged so as to be detachable in the blind-like combination and
the guide plates (5) are divided into overlapping guide plate sections (5.1, 5.2), which can be removed from the frame (1).

2. The grill device according to claim 1, wherein within the support region on the frame (1) the grate sections (2.1-2.n) are provided on both sides with support rails (7) wherein grate bars (8) arranged in parallel are supported so as to be able to rotate.

3. The grill device according to claim 2, wherein the support rails (7) of the grate sections (2.1-2.n) have connecting means in the end regions, via which connecting means a positive connection can be achieved between adjacent support rails (7) arranged on the frame (1).

4. The grill device according to claim 1, wherein the support (1.1) of the frame (1), at the point where the support rails (7) are supported, has latches (9) corresponding to latching means of the support rails (7) such that the grate sections (2.1-2.n) assume a defined position.

5. The grill device according to claim 1, wherein grate sections (2.1-2.n) can be replaced by plates or grill devices for special preparations, wherein the plates or grill devices are supported on the support (1.1) of the frame (1) and can be connected to adjacent grate sections (2.i) by connecting means or have latching means which correspond to the latches (9) of the support (1.1) of the frame (1).

6. The grill device according to claim 1, wherein adjusting the fins (3.1-3.m) is a pivot movement of the fins (3.1-3.m) and the pivot movement can be realised within a pivotal range of at least α=10-65° with reference to a horizontal plane.

7. The grill device according to claim 1, wherein the widths (b) of the fins (3.1-3.m) are dimensioned such that with the pitch angles within the pivotal range α the respective upper lateral area of a fin (3.2) is spaced at a distance (x) from the lower lateral area of the adjacent fin (3.1) in a top view.

8. The grill device according to claim 1, wherein the heating means (4) comprise elongated burners or heating rods and one grate section (2.1-2.n) is provided for one or two burners/heating rods.

9. The grill device according to claim 1, wherein the heating means (4) can be activated and/or adjusted as to their heating power separately from one another.

10. The grill device according to claim 1, wherein the upper edge region of the frame (1) has vertical insertion openings (10), which, between one another, have a grid dimension (z), such that grill add-on elements having spigots (12) spaced apart with the same grid dimension can be inserted into the insertion openings (10) so as to form a positive connection.

11. The grill device according to claim 1, wherein a cover hood (13) for the grill zone is arranged on the frame (1), which cover hood can be opened via hinges, wherein the hinges can be displaced downwardly/upwardly on the back wall of the frame (1).

12. The grill device according to claim 1, wherein instead of fin-shaped covers sheet metal angles (15) with their opening facing the grate (2) are arranged above the heating means (4) and grease accumulating therein can be deflected by a slope in the longitudinal direction of the sheet metal angle.
